(19) United States
(12) Patent Application Publication
(10) Pub. No.: US 2024/0053489 A1
(43) Pub. Date: Feb. 15, 2024

(54) INFORMATION PROCESSING DEVICE, INFORMATION PROCESSING METHOD, AND STORAGE MEDIUM

(71) Applicant: CASIO COMPUTER CO., LTD., Tokyo (JP)

(72) Inventor: Yuuki OSHITA, Tokyo (JP)

(73) Assignee: CASIO COMPUTER CO., LTD., Tokyo (JP)

(21) Appl. No.: 18/364,287

(22) Filed: Aug. 2, 2023

(30) Foreign Application Priority Data
Aug. 10, 2022 (JP) 2022-127668

(51) Int. Cl. G01S 19/39; G01S 19/19

(52) U.S. Cl. CPC G01S 19/396; G01S 19/19

(57) ABSTRACT

An information processing device includes: a control unit configured to perform the following: acquiring data of one or more items related to a positioning result by a positioning operation unit that performs satellite positioning and to an accuracy of the positioning result; and judging that the positioning result is valid when the data of the one or more items meet respective predetermined criteria and outputting the positioning result as valid, wherein the one or more items are not changed depending on a usage type of the positioning result, and the respective predetermined criteria are determined in accordance with the usage type of the positioning result, and wherein the predetermined criteria include a criterion value by which the control unit judges that the criterion is met regardless of a content of the data.

### BACKGROUND OF THE INVENTION

### Technical Field

The present invention relates to an information processing device, an information processing method, and a storage medium.

### Background Art

In portable electronic devices, there is a technique of receiving radio waves from positioning satellites associated with GNSS (Global Navigation Satellite System), performing satellite positioning, and acquiring changes in the current position as a log. In satellite positioning, in principle, three-dimensional positioning requires reception of radio waves from four or more satellites, and two-dimensional positioning requires reception of radio waves from three or more satellites. In addition, the positional relationship of the positioning satellites from which the radio waves are received, that is, the degree of variation when looking up at the sky from the electronic device, also affects the positioning accuracy.

Japanese Patent Application Laid-Open No. 2004-233186 discloses a technology that uses a combination of satellite positioning and dead reckoning in which a vehicle speed sensor, and an orientation sensor are used to calculate the movement amount and movement direction of the device itself in tracking the current position. This reference discloses a technique for increasing the positioning accuracy by using dead reckoning in combination, compared to the case where the current position is specified by satellite positioning alone, and improving the correction accuracy of dead reckoning.

### SUMMARY OF THE INVENTION

Features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides an information processing device, comprising: a control unit configured to perform the following: acquiring data of one or more items related to a positioning result by a positioning operation unit that performs satellite positioning and to an accuracy of the positioning result; and judging that the positioning result is valid when the data of the one or more items meet respective predetermined criteria and outputting the positioning result as valid, wherein the one or more items are not changed depending on a usage type of the positioning result, and the respective predetermined criteria are determined in accordance with the usage type of the positioning result, and wherein the predetermined criteria include a criterion value by which the control unit judges that the criterion is met regardless of a content of the data.

In another aspect, the present disclosure provides a method executed by a control unit in an information processing device, comprising: acquiring data of one or more items related to a positioning result by a positioning operation unit that performs satellite positioning and to an accuracy of the positioning result; and judging that the positioning result is valid when the data of the one or more items meet respective predetermined criteria and outputting the positioning result as valid, wherein the one or more items are not changed depending on a usage type of the positioning result, and the respective predetermined criteria are determined in accordance with the usage type of the positioning result, and wherein the predetermined criteria include a criterion value by which the control unit judges that the criterion is met regardless of a content of the data.

In another aspect, the present disclosure provides a non-transitory computer readable storage medium storing a program executable by at least one processor in an information processing device, the program causing the at least one processor to perform the following: acquiring data of one or more items related to a positioning result by a positioning operation unit that performs satellite positioning and to an accuracy of the positioning result; and judging that the positioning result is valid when the data of the one or more items meet respective predetermined criteria and outputting the positioning result as valid, wherein the one or more items are not changed depending on a usage type of the positioning result, and the respective predetermined criteria are determined in accordance with the usage type of the positioning result, and wherein the predetermined criteria include a criterion value by which the at least one processor judges that the criterion is met regardless of a content of the data.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a block diagram showing the functional configuration of an electronic timepiece.

FIG. 2 is a chart showing the contents of the reference value table used for accuracy determination.

FIG. 3 is a flowchart showing the control procedure of positioning control processing executed by the electronic timepiece.

FIG. 4 is a flowchart for explaining the content of the position accuracy determination process.

FIG. 5 is a chart showing another example of the reference value table.

### DETAILED DESCRIPTION OF EMBODIMENT

The results of satellite positioning is used for various purposes as is. In these cases, it may be inappropriate to judge validity of satellite positioning based on a predetermined uniform accuracy level. On the other hand, if the criteria for determining validity for satellite positioning are set up for each usage separately, the number of similar repetitive processes increases, resulting in poor efficiency.

Embodiments of the present invention will be described below with reference to the drawings.

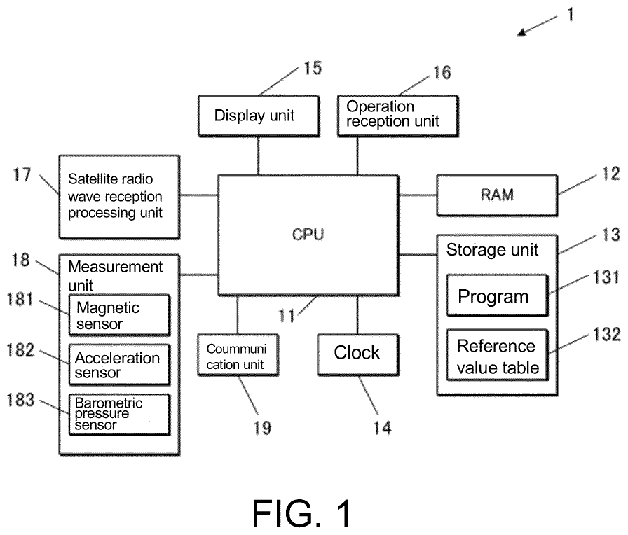

FIG. 1 is a block diagram showing the functional configuration of an electronic timepiece 1 including an information processing device according to this embodiment.

The electronic timepiece 1 includes a CPU 11 (Central Processing Unit) (control unit), a RAM 12 (Random Access Memory), a storage unit 13, a clock unit 14, a display unit 15, an operation reception unit 16, a satellite radio wave reception processing unit 17 (positioning operation unit), a measurement unit 18, a communication unit 19, and the like.

The CPU 11 is a processor that performs arithmetic processing and controls the overall operation of the electronic timepiece 1. The CPU 11 may be a single processor, or a plurality of processors that operate in parallel or independently depending on the applications. The CPU 11 acquires the positioning result from the satellite radio wave reception processing unit 17 as the acquisition unit of this embodiment.

The RAM 12 provides working memory space to the CPU 11 and stores temporary data.

The storage unit 13 is a non-volatile memory, such as a flash memory. The storage unit 13 stores and holds a program 131, setting data, and the like. The setting data includes the reference value table 132. The reference value table 132 includes reference values (numerical values that serve as criteria for judgment) used for determining the accuracy of positioning results.

The CPU 11, RAM 12 and storage unit 13 are included in the information processing apparatus and computer of this embodiment.

The clock unit 14 counts the current date and time based on a signal of a certain frequency emitted by an oscillation circuit (not shown). The clock unit 14 may be a dedicated clock circuit, or may be part of the processing of the CPU 11.

The display unit 15 displays the current time and various functions of the electronic timepiece 1. The display unit 15 may have hands, a gear train (wheel train mechanism), and a stepping motor to perform a hands-type display. Alternatively, the display unit 15 may have a liquid crystal display screen (LCD) or the like to perform digital display.

The operation reception unit 16 receives an external operation by a user or the like and outputs an operation signal to the CPU 11. The operation reception unit 16 has, for example, a push button switch that receives a pressing operation, a crown that receives a pull-out operation and a rotation operation, and the like.

The satellite radio wave reception processing unit 17 receives radio waves from positioning satellites related to GNSS, demodulates them, and performs satellite positioning by performing positioning calculations based on the demodulated contents. The satellite radio wave reception processing unit 17 has an antenna, a receiver for receiving radio waves, and a calculation processing unit for performing positioning calculations. Positioning satellites include, but are not limited to, those related to GPS (Global Positioning Satellite) and Michibiki (registered trademark) related to Quasi-Zenith Satellite System. The arithmetic processing unit can output the movement status of the current position in addition to the identified current position as the positioning results. Also, the arithmetic processing unit can output data relating to the accuracy of the positioning result. These contents may be output according to the format of NMEA-0183 (National Marine Electronics Association). Alternatively, the arithmetic processing unit may output the positioning results in a proprietary format.

The measurement unit 18 measures physical quantities. The measuring unit 18 has, for example, a magnetic sensor 181, an acceleration sensor 182, and a barometric pressure sensor 183. The magnetic sensor 181 measures the earth's magnetic field and outputs the measurement result to the CPU 11. The acceleration sensor 182 measures three-dimensional acceleration and outputs the measurement result to the CPU 11. The measured three-dimensional acceleration may include gravitational acceleration, and in this case, vertical information can be identified according to the gravitational acceleration. The barometric pressure sensor 183 measures atmospheric pressure. Since the air pressure decreases as the altitude increases, the measured value of the air pressure can be converted into altitude by the CPU 11. That is, the barometric pressure sensor 183 can also be used as an altitude sensor. Further, changes in atmospheric pressure may be used by the CPU 11 to determine changes in weather conditions.

The communication unit 19 controls transmission and reception of data with external devices according to a predetermined communication standard. The communication standard is, for example, short-range wireless communication such as Bluetooth (registered trademark) or wireless LAN (Local Area Network).

Next, the positioning result output operation by the electronic timepiece 1 of this embodiment will be described.

In the electronic timepiece 1, the CPU 11 acquires the positioning result output by the satellite radio wave reception processing unit 17 and data relating to its accuracy, and the CPU 11 evaluates the accuracy of the positioning result. The accuracy data includes evaluation parameters (here, numerical values) of multiple items relating to the accuracy. Then, when it is judged that the data for all of the respective items of accuracy satisfy the corresponding standards/criteria (OK), the specified data such as the current position (positioning result) is output as valid data. For example, the data may be output to the storage unit 13 as a movement history and stored, or may be converted into display data, output to the display unit 15, and displayed. Alternatively, the data may be transmitted and output to an external device via the communication unit 19. In this case, the data may be transmitted while being buffered in the RAM 12 as necessary. If it is determined that any item of data related to accuracy does not meet the criteria (NG), the positioning result is determined not to be valid data and is not output.

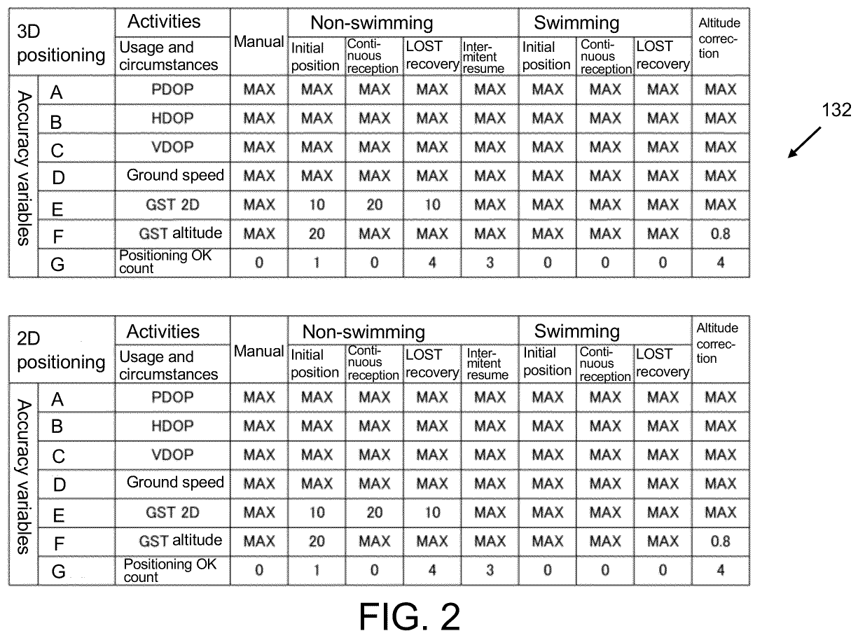

FIG. 2 is a chart showing the contents of the reference value table 132 used for accuracy determination.

In the electronic timepiece 1, the reference values A to G, which serve as criteria for judgment of multiple items used for accuracy judgment (or simply judgment), are changed according to the usage of the positioning result and the acquisition circumstances/status of the positioning result. The usage here include, for example, acquisition of the movement log of the device (that is, the electronic watch 1 including the information processing device) according to various user activities (types of user activities), calibration of the barometric pressure sensor 183 for altitude measurement for the activities that accompany the altitude changes, such as mountain climbing, skiing, touring (bicycle), etc., and other cases where the user requests acquisition of the current position or current date and time by manual operations in any situation (for example, when the user wants to temporarily specify the current position on the map, or when the user wants to correct the current time that is being displayed). The activities here may include, in addition to the above, walking (walking, Nordic walking, etc.), running (jogging, running, marathon, etc.), swimming, skating, and the like.

In addition, the acquisition circumstances/status of positioning results to be considered here include the continuing status of positioning operations and the success or failure of the previous positioning. Specifically, the classifications of the acquisition circumstances to be considered here include situations such as whether or not the positioning is the first position determination after the positioning operation is started (initial positioning), whether or not the positioning has been performed continuously (continuous reception), whether or not the positioning is a resumption of position acquisition when position acquisition is performed intermittently (intermittent resumption), and whether or not the positioning is a specific resumption (LOST recovery) of position acquisition when previous position acquisition failed (LOST). In addition, whether or not the positioning is normal three-dimensional positioning (3D positioning) or two-dimensional positioning (2D positioning) in which the altitude is fixed to a set value or an acquired value can be included in the acquisition circumstances of positioning results. In FIG. 2, reference value tables 132 are defined separately for 3D positioning and 2D positioning.

Based on the positioning result and accuracy data periodically input from the satellite radio wave reception processing unit 17 during the positioning operation of the satellite radio wave reception processing unit 17, for example, the CPU 11, stores, in the RAM 12 as the positioning status (data relating to the acquisition circumstances), the date and time of the previous positioning result, whether or not the current position was specified in the results, and whether or not the positioning operation was interrupted after the previous positioning result was input. By referring to these stored data, the CPU 11 can determine the above-described one of the circumstances, such as the initial positioning, continuous reception, intermittent resumption, or recovery from LOST.

In the reference value table 132, each reference value is defined (stored) in association with the combination of these usages and the acquisition circumstances/status. The activities are further distinguished between swimming and non-swimming.

The variables (accuracy variables) for which reference values can be set include, for example, each value of DOP (Dilution of Precision), ground speed related to movement of the current position, horizontal component and altitude component of GST (Pseudo range Noise Statistics), etc.

The DOP is a collection of parameters determined based on the variation (orientation) of the relative position with respect to the current positions of the positioning satellites from which the radio wave signals are received and used for positioning calculations, and includes PDOP (Position Dilution of Precision), HDOP (Horizontal Dilution of Precision), and VDOP (Vertical Dilution of Precision). PDOP is an index for the accuracy of the specified three-dimensional position, HDOP is an index for the horizontal component, and VDOP is an index for the vertical component.

GST is an index based on the standard deviation of the error of the specified position. In FIG. 2, GST2D indicates the root mean square of the standard deviation of two horizontal error components (latitude error and longitude error). GST Altitude indicates the standard deviation of vertical error (altitude error).

In addition, depending on the usage and situation, it is possible to make it a condition for accuracy judgment that measurement results that satisfy the standard value for accuracy are obtained multiple times in succession. That is, in some of the above combinations, the criteria may be that the current position is successfully identified a plurality of times in succession (the number of consecutive identifications (i.e., the OK count) is 2 or more).

Among the above combinations, when acquiring movement logs for activities other than swimming, for initial position identification and LOST recovery, the reference value is lower than others, that is, a stricter reference is set. In these cases, if a result with a large deviation is specified, it will greatly affect the calculated movement distance, etc., so it is necessary to determine it more accurately.

Compared to these, the reference values are high, that is, the criteria are low, for continuous reception and intermittent resumption. In these cases, even if results with low accuracy are temporarily included, the movement log data may be edited by an application program (which may be an application software in an external device connected by communication) that can be used later.

For the accuracy variable with the reference value set to “MAX”, no matter what the value of the accuracy variable is obtained (regardless of the content of the data related to accuracy), the positioning result will be considered OK (meaning that the criteria are met) as the accuracy judgment. The value assigned to “MAX” may be, for example, the maximum value that can be calculated by the satellite radio wave reception processing unit 17. In other words, the accuracy variables whose reference values are set to “MAX” are practically not used for judgment and have no effect on accuracy judgment. As shown in this exemplary table, only the accuracy variables related to GST are used for actual determination, and the accuracy variables related to ground speed and DOP are set so as not to affect the result of accuracy determination at all. Here, if there exits an accuracy variable in which the higher the value of the accuracy variable, the higher the accuracy, the reference value for not using the accuracy variable for accuracy determination should be the minimum value, that is, “MIN”. Further, if the accuracy is not represented by a numerical value, for example, if the accuracy is graded by identification symbols such as alphabets, the accuracy variable can be prevented from being used for the accuracy determination by using the lowest evaluation identification symbol as the reference value.

In the electronic timepiece 1, the storage areas for all the accuracy variables that can be used are reserved in advance in the reference value table 132. In addition, in the electronic timepiece 1, the accuracy determination processing itself is performed for all of these accuracy variables regardless of the combination of the usage and acquisition circumstances of the positioning results. However, the reference values for criteria of judgment can differ. The reference values may be changeable later by updating the setting data or by manual setting by the user. The accuracy judgment processing program does not need to be updated even if the number or combination of accuracy variables used for judgment is changed.

In the electronic timepiece 1, the positioning results obtained in response to a manual current position request (including the request for the current date and time) are output as is with an accuracy judgment of OK as long as the current position is specified by the satellite wave reception processing unit 17. That is, in this case, outputting the current position and the current date and time according to the user's request is given priority over improving the accuracy.

As described above, while the atmospheric pressure decreases as the altitude increases, the atmospheric pressure also changes according to the weather conditions even at the same altitude. Therefore, when calculating the absolute value of the altitude from the value of the pressure measured by the barometric pressure sensor 183, it is necessary to correct the relationship between the altitude and the absolute value of the atmospheric pressure according to the weather conditions. Such corrections may be made in advance and/or during the activity in response to changing weather conditions. In the altitude correction, the altitude obtained as a result of satellite positioning is associated with the atmospheric pressure measured by the barometric pressure sensor 183 at that time. Therefore, while the altitude measurement accuracy at this time must be sufficiently high, a high position accuracy in the horizontal direction is not required.

The ground speed, that is, the moving speed of the user of the electronic timepiece 1, may change inappropriately if the horizontal position in the positioning results scatters each time. Therefore, when a ground speed that is larger than the speed that can possibly occur during certain activity is output, it cannot be said that sufficient accuracy is obtained. In this embodiment, the reference value is set to MAX in all the cases for the ground speed, but the reference value may be set according to the actual maximum value of the ground speed that can possibly occur.

For activities such as swimming where changes in the height direction are not expected and for activities such as marathons and jogging where changes in the height direction are not considered important, the satellite radio wave reception processing unit 17 may perform two-dimensional positioning (2D positioning) that fixes the height directional position and that specifies only the horizontal positions. As described above, this reduces the number of positioning satellites required for position determination. In other words, if the radio waves are received from the same set of positioning satellites, the 2D positioning has more choices in the number of received radio waves, so that a more accurate result is likely to be obtained. Or, when it is difficult to perform sufficient 3D positioning such as where there is a shortage of positioning satellites from which radio waves can be received for accurate 3D positioning, or where there is a large bias in the orientations of the positioning satellites, the system may be configured to switch to 2D positioning from 3D positioning. In this case, the reference value of the accuracy variable related to DOP during 2D positioning may be set larger (i.e., lower accuracy). In FIG. 2, the setting values of the reference value are the same for 2D positioning and 3D positioning. However, when performing 2D positioning, some of the reference values A to G may be set differently from those in the case of three-dimensional positioning (3D positioning).

Also, in the LOST recovery or intermittent resumption occurs, the positioning result can be regarded as OK only after successfully identifying the current position several times in a row. In particular, when positioning becomes successful after previous positioning fails under poor reception conditions, the reception conditions may not immediately improve significantly, or when positioning fails, the reception conditions immediately before such positioning failure may have already deteriorated and positioning errors might have been large. As a result, the newly specified position may deviate from the actual position greatly. Therefore, the positioning result is solidified after it is confirmed that the positioning has been successful with some stability (i.e., plural times).

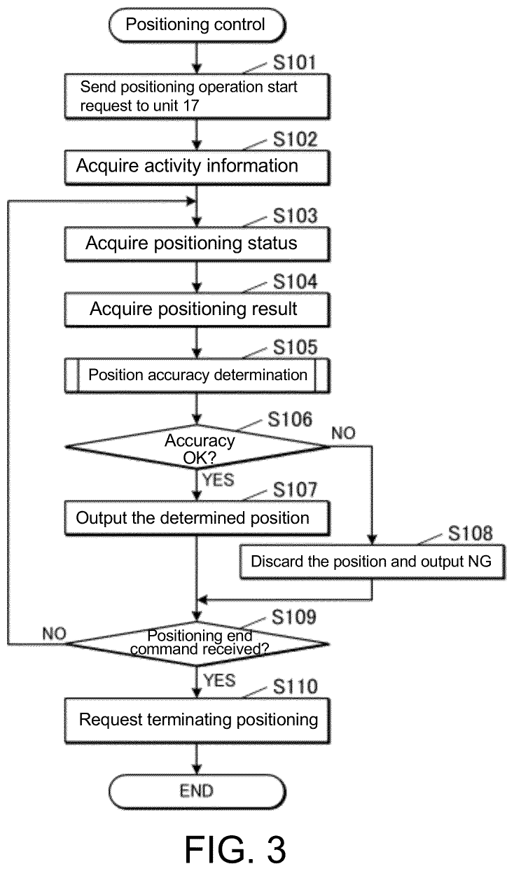

FIG. 3 is a flow chart showing the control procedure by the CPU 11 of the positioning control process executed by the electronic timepiece 1 of this embodiment.

This positioning control process includes an information processing method of this embodiment. The positioning control process is started by reading and executing the program 131 in response to a user's operation or a call from another application program. A type of activity is selected and set in advance by an application program that generates a movement log according to the activity and that measures the amount of exercise.

The CPU 11 activates the satellite radio wave reception processing unit 17 and outputs a positioning operation start request to the satellite radio wave reception processing unit 17 (step S101). The CPU 11 acquires activity information (step S102). The CPU 11 records information related to the activity type that is set by the program for the activity log recording operation.

The CPU 11 acquires the positioning status (step S103). Here, CPU 11 reads the positioning status stored in RAM 12.

The CPU 11 acquires the positioning result from the satellite radio wave reception processing unit 17 (step S104; acquisition step, acquisition process). The CPU 11 executes position accuracy determination processing, which will be described later (step S105; determination step, determination process).

The CPU 11 determines whether or not the accuracy is OK (the positioning result is valid) by the position accuracy determination process (step S106). When it is determined that the accuracy is acceptable (“YES” in step S106), the CPU 11 outputs the position (current position) included in the positioning result to an output target (step S107). Then, the processing of the CPU 11 proceeds to step S109.

If it is determined that the accuracy is not OK (NG, the positioning result is invalid) (“NO” in step S106), the CPU 11 discards the determined position data and outputs the result NG to the output target (step S108). Alternatively, the CPU 11 may not output the result to the output target in this case. Then, the processing of the CPU 11 proceeds to step S109.

Upon proceeding to the process of step S109, the CPU 11 determines whether or not a positioning end command has been acquired (step S109). When it is determined that the positioning end command has not been acquired (“NO” in step S109), the processing of the CPU 11 returns to step S103. If it is determined that the positioning end command has been acquired (“YES” in step S109), the CPU 11 requests the satellite radio wave reception processing unit 17 to stop the positioning operation (step S110). Thereby, the CPU 11 terminates the positioning control process.

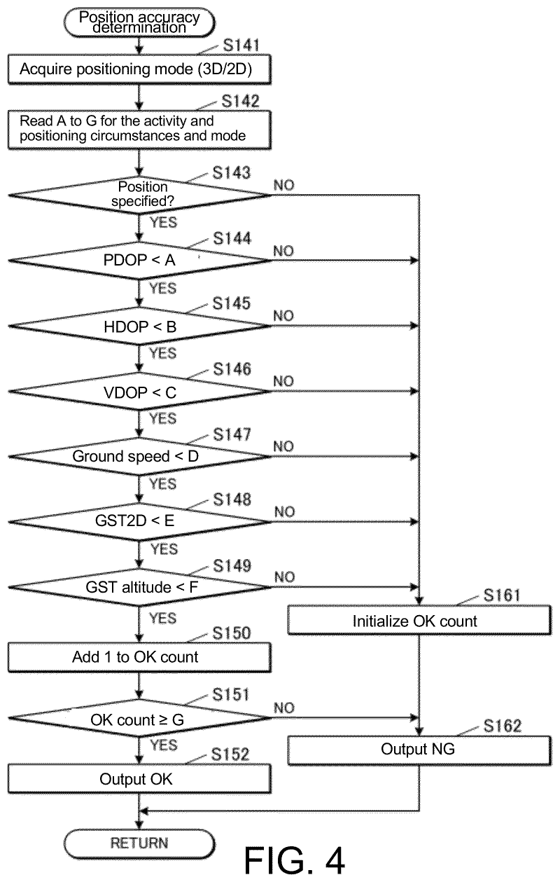

FIG. 4 is a flowchart for explaining the content of the position accuracy determination process.

This position accuracy determination process is called and executed within the positioning control process.

When the positional accuracy determination process is called, the CPU 11 identifies the positioning mode, that is, information on whether it is 2D positioning or 3D positioning (step S141). Positioning mode information is included in the output data in the NMEA-0183 GPGSA (GPS only) or GNGSA (including GLONASS) format.

The CPU 11 reads from the reference value table 132 the reference values A to G corresponding to the combination of the activity information, the positioning status, and the positioning mode (step S142; setting the reference values according to the usage and acquisition circumstances). The CPU 11 determines whether or not the current position is specified in the positioning result (step S143). The GPGGA format of NMEA-0183 includes, in addition to the current location data (latitude, longitude, altitude), as the position specifying quality, numerical values indicating that the position is not specified (“0”), the position is specified by the standard positioning (SPS) (“1”), etc. If it is determined that the current position has not been specified (“NO” in step S143), the processing of the CPU 11 proceeds to step S161.

When it is determined that the current position has been identified (“YES” in step S143), the CPU 11 determines whether PDOP is less than the reference value A (step S144). The PDOP, HDOP and VDOP data are included in the output data in the format of GPGSA (GNGSA). When it is determined that the PDOP is not less than the reference value A (equal to or more than the reference value A) (“NO” in step S144), the process of the CPU 11 proceeds to step S161.

When it is determined that PDOP is less than reference value A (“YES” in step S144), the CPU 11 determines whether HDOP is less than reference value B (step S145). When it is determined that the HDOP is not less than the reference value B (equal to or more than the reference value B) (“NO” in step S145), the CPU 11 proceeds to step S161.

When it is determined that HDOP is less than reference value B (“YES” in step S145), the CPU 11 determines whether VDOP is less than reference value C (step S146). If it is determined that the VDOP is not less than the reference value C (equal to or more than the reference value C) (“NO” in step S146), the process of the CPU 11 proceeds to step S161.

When it is determined that VDOP is less than the reference value C (“YES” in step S146), the CPU 11 determines whether the ground speed is less than the reference value D (step S147). Ground speed is included in the output data in NMEA-0183 GPVTG (GPS only) or GNVTG (including GLONASS) format. If it is determined that the ground speed is not less than the reference value D (equal to or more than the reference value D) (“NO” in step S147), the CPU 11 proceeds to step S161.

When it is determined that the ground speed is less than the reference value D (“YES” in step S147), the CPU 11 determines whether GST2D is less than the reference value E (step S148). The standard deviations of the latitude error, longitude error, and the altitude error concerning GST2D and GST altitude are included in the output data in NMEA-0183 GPGST (GPS only) or GNGST (including GLONASS) format. When it is determined that GST2D is not less than the reference value E (equal to or more than the reference value E) (“NO” in step S148), the process of the CPU 11 proceeds to step S161.

When it is determined that GST2D is less than the reference value E (“YES” in step S148), the CPU 11 determines whether the GST altitude is less than the reference value F (step S149). If it is determined that the GST altitude is not less than the reference value F (equal to or more than the reference value F) (“NO” in step S149), the CPU 11 proceeds to step S161.

When it is determined that the GST altitude is less than the reference value F (“YES” in step S149), the CPU 11 adds 1 to the OK count (step S150). The CPU 11 determines whether or not the OK count is greater than or equal to the reference value G (step S151). When it is determined that the OK count is not equal to or greater than the reference value G (less than the reference value G) (“NO” in step S151), the processing of the CPU 11 proceeds to step S162.

When it is determined that the OK count is greater than or equal to the reference value G (“YES” in step S151), the CPU 11 outputs the determination result that the accuracy is “OK” (step S152). The CPU 11 then ends the accuracy determination process and returns the process to the positioning control process.

When branching to “NO” in each determination process of steps S143 to S149 and moving to the process of step S161, the CPU 11 initializes the OK count (step S161). Then, the processing of the CPU 11 proceeds to step S162.

In the process of step S162, the CPU 11 outputs the determination result that the accuracy is “NG” (step S162). Then, the CPU 11 ends the accuracy determination process and returns the process to the positioning control process.

The reference values will not change unless the activity or reception circumstances (positioning status) change. Therefore, if there is no change from the previous positioning status or the like, the CPU 11 can omit the process of step S142.

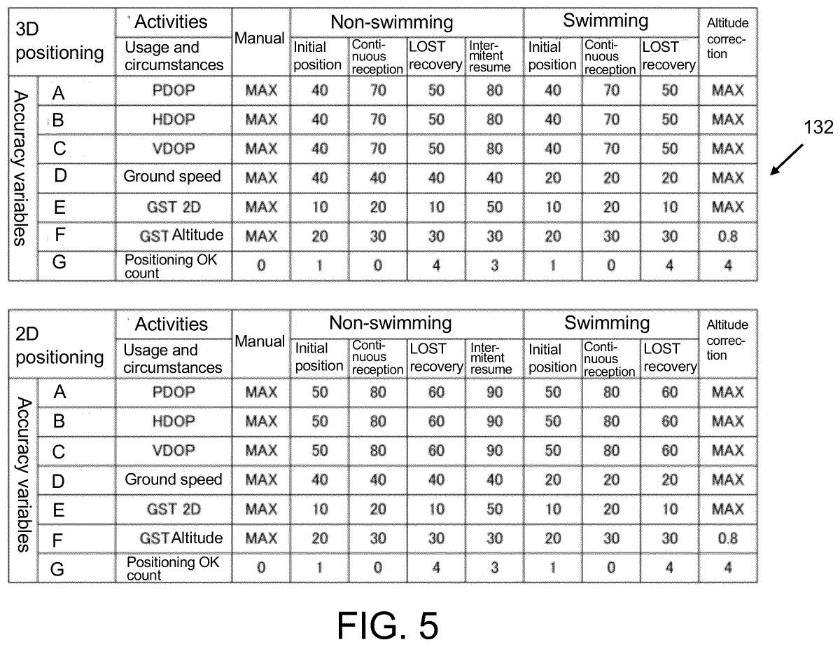

FIG. 5 is a chart showing another example of the reference value table 132. Unlike the example shown in FIG. 2, in this example, the reference values for DOP and ground speed are also set to values other than MAX. Similarly to GST, the reference values for DOP and ground speed are set to be stricter during initial position determination and LOST recovery than during continuous reception and intermittent resumption. Further, in this reference value table 132, the reference value of the ground speed (judgment related to horizontal movement) for swimming, in which the maximum ground speed should naturally be lower than that during walking or running, is set small (strictly).

Even if each reference value in the reference value table 132 is changed in this way and even if the number of accuracy variables used for accuracy determination is also changed, the processing flow of the positional accuracy determination, as described above, can be applied in the same manner.

As described above, the electronic timepiece 1 including the information processing device of this embodiment includes the CPU 11. The CPU 11, as an acquisition unit, acquires a positioning result by the satellite radio wave reception processing unit 17 that performs satellite positioning, and a plurality of items of data relating to the accuracy of that positioning result. As a control unit, the CPU 11 determines that the positioning result is valid when the data of the plurality of items satisfy respective criteria. The plurality of items used for accuracy determination are common regardless of the usage of the positioning result, but the criteria may change, or in other words, may be determined according to the usage of the positioning result. Further, this criterion includes a criterion (such as “MAX”) for causing the CPU 11 to determine that the criterion is satisfied regardless of the content of the data representing the positioning accuracy. By changing and setting the accuracy determination criteria according to the usage, the electronic timepiece 1 can more flexibly determine the validity of the positioning result. In addition, since only the determination criteria can be changed, the processing procedures can remain the same so that it is not necessary for each application program to individually perform processing of accuracy determination. As a result, in the electronic timepiece 1, the contents of each application program can be simplified and the size thereof can be reduced. On the other hand, in the electronic timepiece 1, for usages where it is not necessary to use all the accuracy variables for judging effectiveness, the criteria for items that are not used for judgment may be set to “MAX” regardless of the value of the accuracy variable, thereby setting the reference value such that a positioning result always satisfies the criterion. As a result, in the electronic timepiece 1, it is possible to easily determine the validity by selectively using the necessary items according to the usage by the identical determination processing flow, so the processing does not become complicated. Therefore, the electronic timepiece 1 can more efficiently and simply determine the validity of the positioning result.

Further, the usage here may include at least one of the user activity type related to the movement of the device itself, the correction of the time being counted, and the correction of the altitude calculated from the measurement value of the barometric pressure sensor. The location and speed of movement of the user differ depending on the user activity. Further, the need for each component of the positioning result itself may be high or low depending on the usage. By appropriately specifying criteria according to these factors, the electronic timepiece 1 can selectively output positioning results with the accuracy required by the user.

Also, the user activity type may include swimming. The criteria for determining horizontal movement when swimming is selected as the user activity may be stricter than the criteria for determining horizontal movement when other user activities are selected. As for swimming, which typically moves at a slower speed than other activities, a criterion may be set so that relative position changes can be accurately generated compared to other activities.

In addition, the criteria for accuracy determination may be determined according to the combination of the usage and the acquisition status/circumstances of positioning results. This acquisition status includes information on the status of the continuing positioning operation by the satellite radio wave reception processing unit 17 and the success or failure of the previous positioning. In this way, the electronic timepiece 1 can flexibly obtain a positioning result with the requisite accuracy by considering both usage and acquisition circumstances, rather than one of them. For example, in the electronic timepiece 1, it is possible to set the accuracy criteria for initial positioning and positioning after a long interval to be different from the case where the positioning results have been continuously successfully obtained. As a result, the electronic timepiece 1 can selectively output positioning results with the accuracy required by the user.

The electronic timepiece 1 also includes a storage unit 13 that stores accuracy determination criteria in association with usage. As a control unit, the CPU 11 reads a reference numerical value from the storage unit 13 and uses it to determine whether or not the corresponding positioning result is valid. By storing the reference values as table data in advance as described above, the electronic timepiece 1 can easily and simply determine the validity of the positioning results in a single determination processing flow simply by reading and setting reference values as necessary.

Further, the electronic timepiece 1 of the present embodiment has a functional configuration as the information processing device described above. By providing the electronic timepiece 1 with the above-described functional configuration, the electronic timepiece 1 can selectively output position information with appropriate accuracy more efficiently and simply.

Further, the information processing method of the present embodiment is executed by the CPU 11, and includes a step of acquiring the positioning result by the satellite radio wave reception processing unit 17 that performs satellite positioning, and a plurality of items of data related to the accuracy of the positioning result, and a judgment step of judging that the positioning result is valid when the plurality of items of data satisfy respective criteria. The plurality of items for the accuracy determination are common regardless of the usage of the positioning result, but their criteria are determined in accordance with the usage of the positioning result. Also, these criteria include a data value, such as “MAX” described above, by which the criteria are always satisfied regardless of the contents of the data.

Such an information processing method enables the electronic timepiece 1 to more efficiently and simply determine the validity of the positioning result. In addition, by making only the determination criteria changeable, it is possible to apply the same processing procedure, and there is no need to separately determine the processing for accuracy determination, which makes the device configuration simpler. On the other hand, for usage where it is not necessary to use all the accuracy variables for judging validity, the criteria for items that are not used for judgment is set to a value, such as “MAX” by which the validity criterion is always satisfied regardless of the value of the accuracy variable. As a result, in the information processing method of the present embodiment, it is possible to make validity determination by selectively using the relevant items according to the usage in the same judgement processing flow, so the processing does not become complicated.

Also, by installing and executing the program 131 of this embodiment, the electronic timepiece 1 can easily and simply perform the processing related to the above information processing method in terms of software.

The present invention is not limited to the above embodiments, and various modifications are possible.

For example, the accuracy variables do not have to be related to the above-mentioned DOP, ground speed and GST. Additionally or alternatively, other accuracy variables may be used.

Further, the acquisition status/circumstances of positioning results is not limited to those described above. Other types of acquisition status/circumstances may be included, or the above acquisition status/circumstances may be further classified into a plurality of subtypes.

Also, the usages of positioning results are not limited to the types described above. Other types may be included, and/or only some (at least some) of those listed above may be included.

Also, the content to be output is not limited to the position determined by positioning. Other positioning results may be output together, and positioning accuracy data may also be output together.

Also, in the above embodiment, the CPU 11 directly acquires the positioning result and accuracy data from the satellite radio wave reception processing unit 17 provided in the device itself, but the present invention is not limited to this. A communication unit 19 (included in the acquisition unit in this case) may acquire positioning results and accuracy data from a satellite radio wave reception processing unit provided in an electronic device that is separate from the electronic timepiece 1, such as a smartphone, and the acquired positioning results may be used in combination of the measurement results of the measurement unit 18. Furthermore, the measurement unit 18 may also be a measurement device separate from the electronic timepiece 1, and may be worn on the user's body from which measurement data can be acquired via the communication unit 19.

Further, the accuracy data is not limited to that obtained from the satellite radio wave reception processing section 17. For example, each value of DOP and the like can be calculated by the CPU 11 by the device itself based on the current position by acquiring the position data of the positioning satellites.

Further, the electronic timepiece 1 of the present embodiment may include any devices that perform timekeeping operations and time display. That is, the electronic timepiece 1 may include smartwatches and activity measurement devices. Moreover, the electronic timepiece 1 is not limited to a wristwatch type. For example, the electronic timepiece 1 may be a portable type that can be stored in a pocket or the like, or it may be a type that can be worn on a body part other than the arm by a band.

In addition, the items for determining accuracy judgment criteria may include things other than the above-mentioned usage and acquisition status/circumstances. For example, the user may be able to select from modes of “result acquisition prioritized (low accuracy)” and “accuracy prioritized (high accuracy)” by performing an input operation to the operation reception unit 16. Also, the device may be configured such that even in the same activity, it is possible to switch the reference values depending on whether the acquisition target desired by the user is the absolute position or the moving distance (moving speed). Conversely, the accuracy criteria may be set individually based on the usage type alone. In the reference value table 132 in this case, the reference values are stored in association with only the usage types.

Also, although the above accuracy determination has been described as being performed by the CPU 11 of the electronic timepiece 1, the present invention is not limited to this. External processing may be performed as long as it is performed by a type of one or more processors, such as a CPU. Also, a plurality of processing contents may be distributed to and executed by a plurality of processors/CPUs, as a plurality of information processing apparatuses.

Further, in the above description, a non-transitory computer-readable medium for storing the program 131 related to the accuracy determination control of the present invention is described as an example of the storage unit 13 made up of a non-volatile memory such as a flash memory. But the present invention is not limited to this. Other computer-readable media include other nonvolatile memories such as HDD (Hard Disk Drive), EEPROM (Electrically Erasable and Programmable Read Only Memory), and MRAM, and portable recording media such as CD-ROM and DVD discs. A carrier wave is also applicable to the present invention as a medium for providing program data according to the present invention via a communication line.

In addition, the specific configurations, contents and procedures of processing operations, etc., described in the above embodiments can be changed as appropriate without departing from the scope of the present invention. The scope of the present invention includes the scope of the invention described in the claims and the scope of equivalents thereof. It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. An information processing device, comprising:
a control unit configured to perform the following:
acquiring data of one or more items related to a positioning result by a positioning operation unit that performs satellite positioning and to an accuracy of the positioning result; and
judging that the positioning result is valid when the data of the one or more items meet respective predetermined criteria and outputting the positioning result as valid,
wherein the one or more items are not changed depending on a usage type of the positioning result, and the respective predetermined criteria are determined in accordance with the usage type of the positioning result, and
wherein the predetermined criteria include a criterion value by which the control unit judges that the criterion is met regardless of a content of the data.

2. The information processing device according to claim 1, wherein the usage type includes at least one of: a user activity type related to a movement of the information processing device due to the user activity type, correction of a time being displayed on the information processing device, and correction of an altitude calculated from a measurement value of a barometric pressure sensor.

3. The information processing device according to claim 2,
wherein the user activity type includes swimming, and
wherein during swimming, a criterion for determining a validity of horizontal movement determined by the positioning result is set to be stricter than a criterion for determining a validity of horizontal movement for another user activity.

4. The information processing device according to claim 1,
wherein the predetermined criteria are determined in accordance with the usage type and an acquisition status of the positioning result, and
wherein the acquisition status includes a continuing status of successful positioning by the positioning operation unit and information on success or failure of previous positioning by the positioning operation unit.

5. The information processing device according to claim 1, further comprising:
a storage unit that stores the predetermined criteria in association with the usage type,
wherein the control unit reads out the predetermined criteria from the storage unit in accordance with the usage type and applies the read out predetermined criteria in the judging.

6. A method executed by a control unit in an information processing device, comprising:
acquiring data of one or more items related to a positioning result by a positioning operation unit that performs satellite positioning and to an accuracy of the positioning result; and
judging that the positioning result is valid when the data of the one or more items meet respective predetermined criteria and outputting the positioning result as valid,
wherein the one or more items are not changed depending on a usage type of the positioning result, and the respective predetermined criteria are determined in accordance with the usage type of the positioning result, and
wherein the predetermined criteria include a criterion value by which the control unit judges that the criterion is met regardless of a content of the data.

7. The method according to claim 6, wherein the usage type includes at least one of: a user activity type related to a movement of the information processing device due to the user activity type, correction of a time being displayed on the information processing device, and correction of an altitude calculated from a measurement value of a barometric pressure sensor.

8. The method according to claim 7,
wherein the user activity type includes swimming, and
wherein during swimming, a criterion for determining a validity of horizontal movement determined by the positioning result is set to be stricter than a criterion for determining a validity of horizontal movement for another user activity.

9. The method according to claim 6,
wherein the predetermined criteria are determined in accordance with the usage type and an acquisition status of the positioning result, and
wherein the acquisition status includes a continuing status of successful positioning by the positioning operation unit and information on success or failure of previous positioning by the positioning operation unit.

10. The method according to claim 6,
wherein the information processing device further includes a storage unit that stores the predetermined criteria in association with the usage type, and
wherein the control unit reads out the predetermined criteria from the storage unit in accordance with the usage type and applies the read out predetermined criteria in the judging.

11. A non-transitory computer readable storage medium storing a program executable by at least one processor in an information processing device, the program causing the at least one processor to perform the following:
acquiring data of one or more items related to a positioning result by a positioning operation unit that performs satellite positioning and to an accuracy of the positioning result; and
judging that the positioning result is valid when the data of the one or more items meet respective predetermined criteria and outputting the positioning result as valid,
wherein the one or more items are not changed depending on a usage type of the positioning result, and the respective predetermined criteria are determined in accordance with the usage type of the positioning result, and
wherein the predetermined criteria include a criterion value by which the at least one processor judges that the criterion is met regardless of a content of the data.

12. The storage medium according to claim 11, wherein the usage type includes at least one of: a user activity type related to a movement of the information processing device due to the user activity type, correction of a time being displayed on the information processing device, and correction of an altitude calculated from a measurement value of a barometric pressure sensor.

13. The storage method according to claim 12,
wherein the user activity type includes swimming, and
wherein during swimming, a criterion for determining a validity of horizontal movement determined by the positioning result is set to be stricter than a criterion for determining a validity of horizontal movement for another user activity.

14. The storage medium according to claim 11,
wherein the predetermined criteria are determined in accordance with the usage type and an acquisition status of the positioning result, and
wherein the acquisition status includes a continuing status of successful positioning by the positioning operation unit and information on success or failure of previous positioning by the positioning operation unit.

15. The storage medium according to claim 11,
wherein the information processing device further includes a storage unit that stores the predetermined criteria in association with the usage type, and
wherein the one or more processor reads out the predetermined criteria from the storage unit in accordance with the usage type and applies the read out predetermined criteria in the judging.

16. The information processing device according to claim 1, wherein the one or more items include one or more of PDOP (Position Dilution of Precision), HDOP (Horizontal Dilution of Precision), VDOP (Vertical Dilution of Precision), ground speed of the device, GST 2D, GST altitude, and a positioning OK count that indicates how many successful positioning occurred consecutively.

17. The information processing device according to claim 1, wherein the one or more items include all of PDOP (Position Dilution of Precision), HDOP (Horizontal Dilution of Precision), VDOP (Vertical Dilution of Precision), ground speed of the device, GST 2D, GST altitude, and a positioning OK count that indicates how many successful positioning occurred consecutively.

18. The method according to claim 5, wherein the one or more items include one or more of PDOP (Position Dilution of Precision), HDOP (Horizontal Dilution of Precision), VDOP (Vertical Dilution of Precision), ground speed of the device, GST 2D, GST altitude, and a positioning OK count that indicates how many successful positioning occurred consecutively.

19. The method according to claim 5, wherein the one or more items include all of PDOP (Position Dilution of Precision), HDOP (Horizontal Dilution of Precision), VDOP (Vertical Dilution of Precision), ground speed of the device, GST 2D, GST altitude, and a positioning OK count that indicates how many successful positioning occurred consecutively.

20. The storage medium according to claim 10, wherein the one or more items include one or more of PDOP (Position Dilution of Precision), HDOP (Horizontal Dilution of Precision), VDOP (Vertical Dilution of Precision), ground speed of the device, GST 2D, GST altitude, and a positioning OK count that indicates how many successful positioning occurred consecutively.
